(19) United States
(12) Patent Application Publication
(10) Pub. No.: US 2026/0244846 A1
(43) Pub. Date: Aug. 20, 2026

(54) DOCUMENT CREATION SUPPORT DEVICE, DOCUMENT CREATION SUPPORT METHOD, AND NON-TRANSITORY COMPUTER-READABLE RECORDING MEDIUM

(71) Applicant: NEC Corporation, Tokyo (JP)

(72) Inventor: Masaru KAWAKITA, Tokyo (JP)

(73) Assignee: NEC Corporation, Tokyo (JP)

(21) Appl. No.: 19/410,115

(22) Filed: Dec. 5, 2025

(30) Foreign Application Priority Data
Feb. 14, 2025 (JP) 2025-022138

(51) Int. Cl. G06F 40/166; G06F 40/247; G06F 40/40

(52) U.S. Cl. CPC G06F 40/166; G06F 40/247; G06F 40/40

(57) ABSTRACT

A document creation support device according to an aspect of the present disclosure includes reception unit that receive an input of instruction information including an instruction regarding contents of a report related to cybersecurity and reader information indicating a type of a reader, generation unit that generate a report including information regarding a threat according to the instruction information based on a result of referring to information related to the instruction information, the report including a matter of interest of the reader associated with the type of the reader, and output unit that output the report generated.

This application is based upon and claims the benefit of priority from Japanese Patent Application No. 2025-022138, filed on February 14, 2025, the disclosure of which is incorporated herein in its entirety by reference.

### TECHNICAL FIELD

The present disclosure relates to a document creation support device, a document creation support method, and a program.

### BACKGROUND ART

To prevent cybercrime, various types of information regarding cybersecurity, such as attack methods and countermeasure methods, need to be grasped. For the information, an analyst may create a report on the cybersecurity. At this time, the analyst may create a report by manually collecting information regarding the cybersecurity and analyzing the collected information.

JP 2022-527511 A discloses a technique for outputting information regarding a cybersecurity event. For example, JP 2022-527511 A describes collecting events and network flow data and generating a report.

### SUMMARY

A document creation support device according to an aspect of the present disclosure includes reception unit that receive an input of instruction information including an instruction regarding contents of a report related to cybersecurity and reader information indicating a type of a reader, generation unit that generate a report including information regarding a threat according to the instruction information based on a result of referring to information related to the instruction information, the report including an interest of the reader associated with the type of the reader, and output unit that output the report generated.

A document creation support method according to an aspect of the present disclosure includes receiving an input of instruction information including an instruction regarding contents of a report related to cybersecurity and reader information indicating a type of a reader, generating a report including information regarding a threat according to the instruction information based on a result of referring to information related to the instruction information, the report including an interest of the reader associated with the type of the reader, and outputting the report generated.

A program according to an aspect of the present disclosure causes a computer to execute processing of receiving an input of instruction information including an instruction regarding contents of a report related to cybersecurity and reader information indicating a type of a reader, processing of generating a report including information regarding a threat according to the instruction information based on a result of referring to information related to the instruction information, the report including an interest of the reader associated with the type of the reader, and processing of outputting the report generated.

### BRIEF DESCRIPTION OF THE DRAWINGS

FIG. 1 is a block diagram illustrating an example of a functional configuration of a document creation support device of the present disclosure;

FIG. 2 is a first flowchart illustrating an example of an operation of the document creation support device of the present disclosure;

FIG. 3 is a diagram schematically illustrating an example of a configuration including the document creation support device of the present disclosure;

FIG. 4 is a first block diagram including an example of a functional configuration of the document creation support device of the present disclosure;

FIG. 5 is a diagram illustrating an example of input display of the present disclosure;

FIG. 6 is a diagram illustrating an example of prompt pattern information of the present disclosure;

FIG. 7 is a diagram illustrating an example of synonym data of the present disclosure;

FIG. 8 is a diagram illustrating an example of a report of the present disclosure;

FIG. 9 is a second flowchart illustrating an example of an operation of the document creation support device of the present disclosure;

FIG. 10 illustrates an example of credibility pattern information of the present disclosure; and

FIG. 11 is a block diagram illustrating an example of a hardware configuration of a computer device that implements the document creation support device of the present disclosure.

### EXAMPLE EMBODIMENT

Hereinafter, example embodiments of the present disclosure will be described with reference to the drawings.

### First example embodiment

An outline of a document creation support device according to a first example embodiment will be described.

The document creation support device of the present disclosure generates a report related to cybersecurity in response to a received instruction. Hereinafter, the cybersecurity may be simply referred to as “security”. The document creation support device outputs the generated report. Here, the document creation support device may be communicably connected to a terminal device through a network. For example, the document creation support device outputs a report to the terminal device. The terminal device is used by a user and has an input/output function. The user may be a person in charge of creating a report, such as a security analyst, or may be a reader of a report having been delivered, for example. That is, the report generated by the document creation support device may be a draft report that can be edited by the person in charge to create the report, or may be a report directly delivered to the reader.

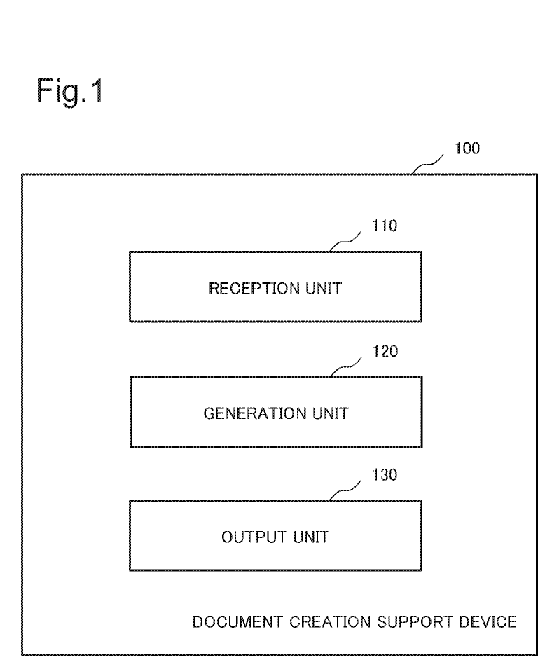

FIG. 1 is a first block diagram illustrating an example of a functional configuration of the document creation support device. As illustrated in FIG. 1, the document creation support device 100 includes a reception unit 110, a generation unit 120, and an output unit 130.

The reception unit 110 receives input of instruction information including an instruction related to contents of the report. The instruction information includes information indicating a theme of the report, for example. The theme indicates features in a cyberattack, such as an attacker, an attack method, a target, a vulnerability, a damage situation, and a type of malware having been used. Hereinafter, the features in the cyberattack are also referred to as information regarding a threat. The theme may indicate information indicating an information source including information regarding the threat, and a language task for the information source, such as summarization and translation. An example of the language task is not limited to this example. For example, the language task may include keyword extraction, sentence structuring, and the like. The instruction information is not limited to these examples.

The reception unit 110 receives also input of information indicating a type of a reader of the report. Examples of the type of the reader include a management executive, an incident responder, and an operator of the system. The type of the reader is not limited to these examples. The information indicating the type of the reader is also referred to as reader information.

The reception unit 110 may receive the instruction information and the reader information acquired from the terminal device, each information having been input by an operation of the user, for example.

As described above, the reception unit 110 receives the input of the instruction information including the instruction related to the contents of the report related to the cybersecurity and the reader information indicating the type of the reader. The reception unit 110 is an example of reception means.

The generation unit 120 generates a report. Specifically, the generation unit 120 may generate a report based on the instruction information and the reader information.

Here, the generation unit 120 may use a learning model. The generation unit 120 may generate a report using a generated sentence having been output from a natural language processing model such as large language models (LLM), for example. As an example, the generation unit 120 inputs a prompt based on the instruction information and the reader information to the natural language processing model, and acquires a generated sentence having been output by the natural language processing model. At this time, the generated sentence includes information regarding a threat according to the instruction information. Additionally, a prompt suitable for the type of the reader may be input. For example, the prompt may include an instruction to output the generated sentence including an interest of the reader. Consequently, the generated sentence having been output from the natural language processing model includes the interest of the reader. Then, the generation unit 120 may generate the report by converting the acquired generated sentence into a format of the report.

The generation unit 120 may generate a report based on a result of referring to information related to the instruction information. For example, the generation unit 120 refers to information related to the instruction information in a predetermined database. Then, the generation unit 120 may generate the report using the generated sentence obtained by inputting the reference result and the prompt to the natural language processing model described above, for example. At this time, the generation unit 120 may search the predetermined database for information regarding a threat included in the instruction information. Then, the generation unit 120 may input a search result and the prompt to a natural language processing model such as the large language models. A method for generating the report is not limited to this example.

As described above, the generation unit 120 generates the report that includes the information regarding the threat according to the instruction information based on the result of referring to the information related to the instruction information, the report including the interest of the reader, suitable for the type of the reader. The generation unit 120 is an example of generation means.

The output unit 130 outputs the report generated. For example, the report may be output to the terminal device by the output unit 130 to display the report on a display provided in the terminal device. The output unit 130 is an example of output means.

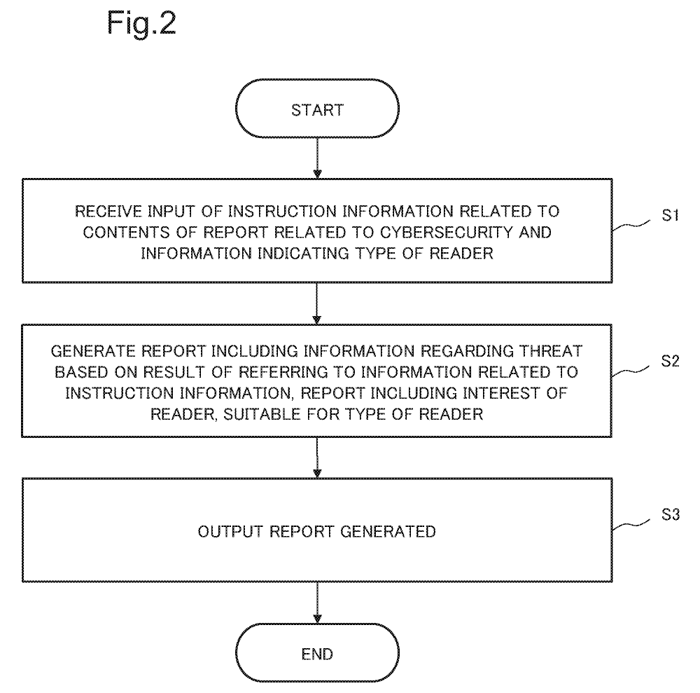

Next, an example of an operation of the document creation support device 100 will be described with reference to FIG. 2. In the present disclosure, each step of the flowchart is represented using a number given to each step, such as “S1”.

FIG. 2 is a first flowchart illustrating an example of the operation of the document creation support device 100.

The reception unit 110 receives the input of the instruction information including the instruction related to the contents of the report related to the cybersecurity and the reader information indicating the type of the reader (S1).

The generation unit 120 generates the report including the information regarding the threat according to the instruction information based on the result of referring to the information related to the instruction information, the report including the interest of the reader, suitable for the type of the reader (S2).

The output unit 130 outputs the report generated (S3).

As described above, the document creation support device 100 according to the first example embodiment receives the input of the instruction information including the instruction related to the contents of the report related to the cybersecurity and the reader information indicating the type of the reader. The document creation support device 100 generates the report including the information regarding the threat according to the instruction information based on the result of referring to the information related to the instruction information, the report including the interest of the reader, suitable for the type of the reader. Then, the document creation support device 100 outputs the report generated.

Consequently, the document creation support device 100 can generate a report assuming needs of the reader. That is, the document creation support device 100 can support creation of a report on cybersecurity, suitable for needs.

### Second example embodiment

Next, a document creation support device according to a second example embodiment will be described. In the second example embodiment, a further example of the document creation support device described in the first example embodiment will be described. Duplicate contents with those of the first example embodiment will not be partially described.

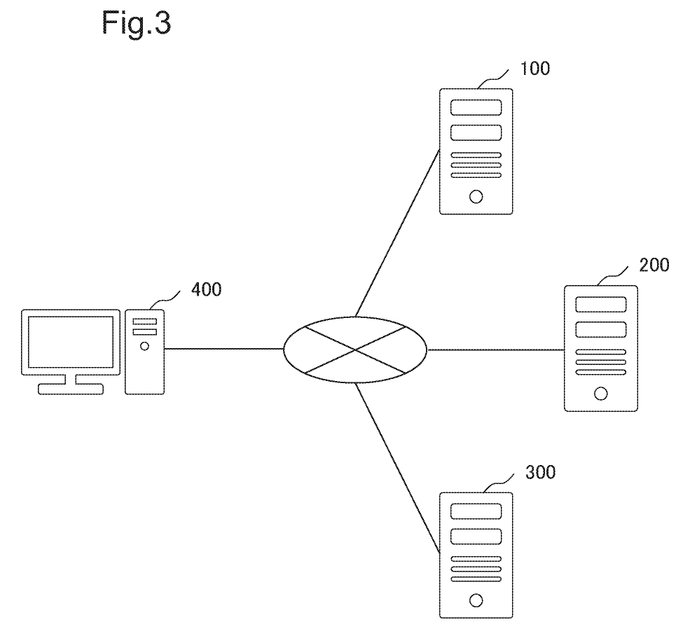

FIG. 3 is a diagram schematically illustrating an example of a configuration including the document creation support device. As illustrated in FIG. 3, the document creation support device 100 is communicably connected to a model management server 200, a collection server 300, and a terminal device 400 through a wired or wireless network.

The model management server 200 includes a learning model. An example of the learning model is a natural language processing model that generates a text according to an input sentence and outputs the generated text. For example, the learning model is the large language models. The large language models are constructed using large data sets and a technique such as deep learning. The large language models may be provided with ability to perform complex language tasks such as text generation, interrogation response, and summarization. In the present disclosure, an example will be described in which the model management server 200 includes the large language models.

The collection server 300 collects information. Specifically, the collection server 300 collects information related to cybersecurity from an external server or the like through a network.

The terminal device 400 is used by a user. Examples of the user include a person involved in creation of a report on cybersecurity. The examples of the user also include an analyst, a security operation center (SOC) operator, a security incident responder, and an operator of the system.

The configuration communicably connected to the document creation support device 100 is not limited to this example. For example, the document creation support device 100 may be capable of communicating with a distribution server. The distribution server has a function of distributing a report output from the document creation support device 100. At this time, the distribution server may distribute directly the report having been generated by the document creation support device 100, or may distribute the report having been generated after being corrected or checked by a person in charge of creating the report. The distribution server and the document creation support device 100 may be the same device. The document creation support device 100 may have a function of distributing a report.

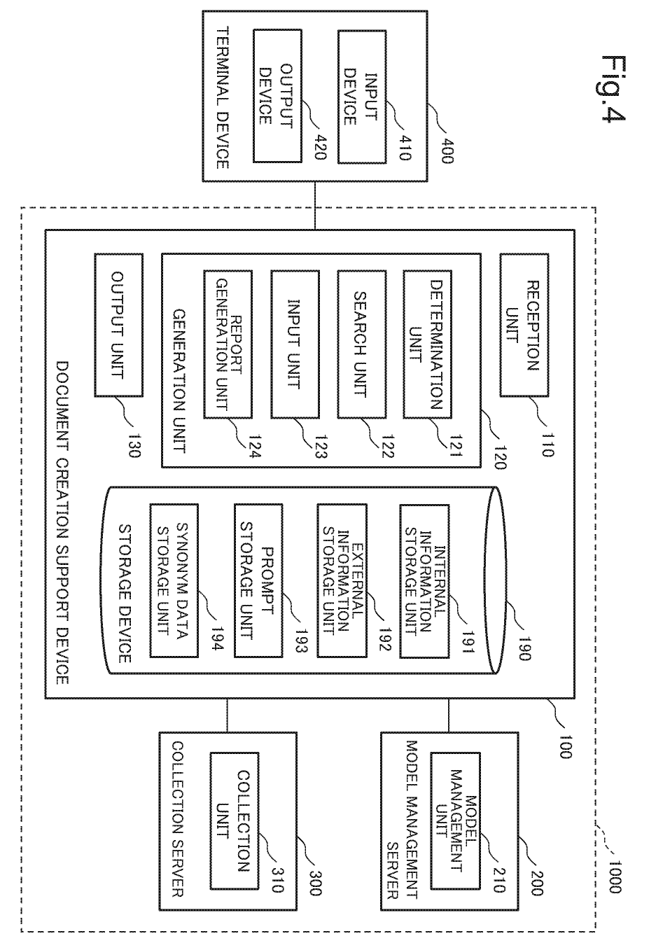

FIG. 4 is a first block diagram including an example of a functional configuration of the document creation support device. Specifically, FIG. 4 illustrates a document creation support system 1000 including the document creation support device 100 and the terminal device 400. The document creation support system 1000 includes the document creation support device 100, the model management server 200, and the collection server 300.

The model management server 200 includes a model management unit 210. The model management unit 210 stores the large language models, a program related thereto, and the like. When receiving a prompt, the model management unit 210 generates a sentence indicating an answer in response to the prompt. Then, the model management unit 210 outputs the generated sentence. At this time, the sentence having been generated by the model management unit 210 is referred to as a generated sentence. Examples of the large language models include GPT-2, GPT-3, GPT-3.5, GPT-4, and GPT-4o. The examples of the large language models also include Claude3, Claude3.5, T5, BERT, RoBERTa, and ELECTRA. The large language models are not limited to this example. The model management server 200 may be provided in the document creation support device 100. For the model management server 200, the document creation support device 100 may include the model management unit 210. The model management server 200 may be an external device capable of communicating with the document creation support system 1000.

The collection server 300 includes a collection unit 310. The collection unit 310 collects various types of information from a device, such as an external server in which information has been accumulated, through a network. At this time, the collection unit 310 collects information related to security. The information collected by the collection unit 310 is also referred to as external information. Examples of the external information include news distributed by mass media, information having been accumulated by related organizations such as government agencies and private organizations that have jurisdiction over security, and posts regarding security in a social networking service (SNS). For example, the collection unit 310 may collect information by a technique such as a crawler. That is, the collection unit 310 may periodically collect information related to security through the network. The collection unit 310 stores the collected external information in a storage device 190 described later.

The terminal device 400 includes an input device 410 such as a keyboard or a touch panel. The terminal device 400 further includes an output device 420 such as a display or a speaker. The terminal device 400 is a personal computer, a smartphone, or a tablet terminal, for example, but is not limited to this example. The terminal device 400 only needs to include the input device 410 capable of inputting instruction information, reader information, and the like, and the output device 420 capable of outputting information output by the document creation support device 100.

The document creation support device 100 includes a reception unit 110, a generation unit 120, and an output unit 130. The document creation support device 100 also includes the storage device 190.

The storage device 190 stores various types of information. The storage device 190 may function as a database server. FIG. 4 illustrates an example in which the storage device 190 includes an internal information storage unit 191, an external information storage unit 192, a prompt storage unit 193, and a synonym data storage unit 194.

The storage device 190 may be an external device capable of communicating with the document creation support device 100. The storage device 190 may include a plurality of storage devices. At this time, some of the plurality of storage devices may be external devices capable of communicating with the document creation support device 100. The storage device 190 includes a plurality of functional units, some of which may be implemented by an external device capable of communicating with the document creation support device 100.

The reception unit 110 receives input of instruction information and reader information. For example, the user inputs the instruction information and the reader information using the input device 410 of the terminal device 400. The information having been input in the terminal device 400 is received by the reception unit 110.

The user may input text data to input the instruction information and the reader information. Specifically, the user may input a sentence as the instruction information. For example, the user may input a sentence “Please organize news regarding the recent attacker ABC10”. The reception unit 110 may receive the sentence having been input in this manner as the instruction information. Alternatively, the user may input a word such as “ABC10” that is the name of the attacker, for example. The reception unit 110 may receive the word having been input in this manner as the instruction information. Alternatively, the user may input information indicating an information source such as a uniform resource locator (URL). That is, the reception unit 110 may receive information indicating the information source as the instruction information. The information included in the instruction information is not limited to this example.

Similarly, the user may input a text indicating a type of the reader. For example, the user may input a text indicating the type of the reader such as an SOC operator or a management executive. The reception unit 110 may receive the text having been input as the reader information.

Besides this example, the user may select an option to input the instruction information and the reader information. For example, the user selects among a plurality of types of instruction information and a plurality of types of reader information, which have been set in advance. The reception unit 110 may receive the instruction information having been selected and reader information as an input.

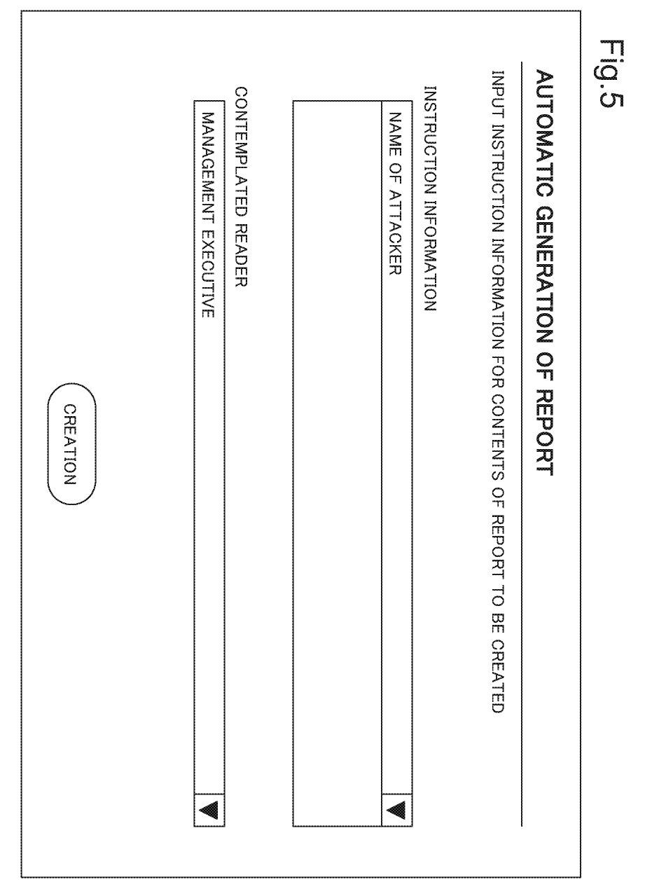

FIG. 5 is a diagram illustrating an example of input display. Specifically, FIG. 5 illustrates an example of an interface for receiving input of the user. This example shows information prompting input of instruction information and reader information. For example, “name of attacker” is selected in an input field of instruction information as a type of the information. As described above, the user may select an option of the type of the information to be input to the instruction information. Then, the user inputs the name of the attacker for this example. Additionally, “management executive” is selected in an input field of the reader information. As described above, the user may select an option of the type of the reader. The user inputs the reader information by selecting any one of options for this example. Input display as in the example of FIG. 5 may be displayed on the terminal device 400 by the output unit 130, for example.

The generation unit 120 generates a report. As illustrated in FIG. 4, the generation unit 120 includes a determination unit 121, a search unit 122, an input unit 123, and a report generation unit 124.

The determination unit 121 determines a prompt to be input to the large language models based on the instruction information and the reader information. The determined prompt indicates contents associated with the instruction information and the reader information. The instruction information includes information indicating a theme of the report. That is, the determination unit 121 determines a prompt including an instruction to generate a sentence according to the theme of the report indicated in the instruction information. The determination unit 121 determines also a prompt suitable for a type of the reader.

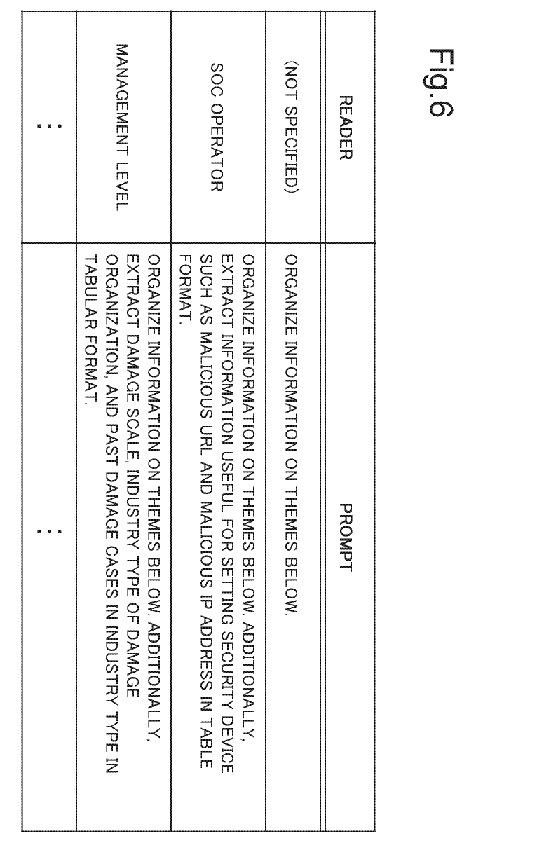

The determination unit 121 may determine the prompt by using a prompt stored in the prompt storage unit 193. At this time, the prompt storage unit 193 stores prompt pattern information including the prompt. FIG. 6 is a diagram illustrating an example of the prompt pattern information. The example of FIG. 6 shows the type of the reader and the prompt that are associated with each other. Specifically, “SOC operator” as a type of the reader is associated with a prompt, “Please not only summarize information on the following themes, but also extract information useful for setting of a security device, such as malicious URLs and malicious IP addresses, in a tabular format”. That is, this example shows the prompt including an instruction to output information related to the setting of the security device for the reader being an SOC operator. Similarly, a prompt includes an instruction to output a damage scale, an industry type of a damaged organization, and a past damaged example, for the reader being a person of a management level. As described above, the prompt includes an instruction to output information on an interest of a reader for each type of reader. The interest of the reader may be information indicating information desired by the reader among information regarding a threat as in these examples.

The prompt associated with the type of the reader is not limited to these examples. For example, the reader is assumed to be a responder of an incident. At this time, the associated prompt may include an instruction to output details of an operation related to software (malware) having been used for an attack, for example. For the reader being an operator of the system, for example, an instruction to output peripheral information on an attack technique such as information on software similar to software having been used for the attack and information on a network of a damaged system may be included.

For example, the instruction information is assumed to indicate a theme “ABC10” as a name of the attacker. Additionally, the reader information is assumed to indicate a type of “SOC operator”. At this time, the determination unit 121 selects a prompt associated with the type of “SOC operator”. Then, the determination unit 121 determines a prompt acquired by integrating the theme of “attacker ABC10” included in the instruction information and the prompt having been selected as a prompt to be input to the model management unit 210 (large language models).

The prompt may include a further instruction. For example, the prompt may include an instruction of an output format.

As described above, the determination unit 121 determines a prompt including an instruction to generate a sentence according to the theme, the prompt being associated with the type of the reader. The determination unit 121 is an example of determination means.

Here, the determination unit 121 may determine a prompt in consideration of a synonym of a term. Terms may have synonyms. For example, names of an attacker, an attack method, malware, and the like may include aliases. A word indicating a concept identical or similar to a term, such as an alias described above, is referred to as a synonym.

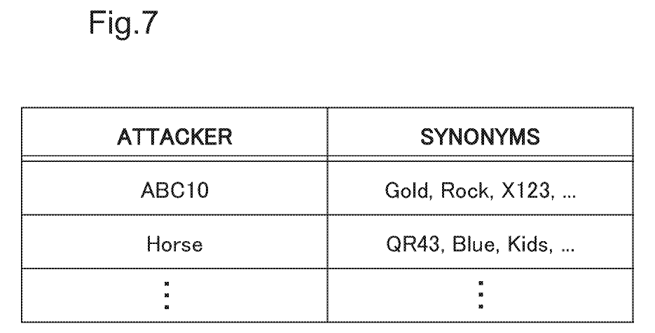

For the prompt, the determination unit 121 identifies a synonym of a term included in the instruction information by using synonym data. The synonym data is stored in the synonym data storage unit 194. FIG. 7 is a diagram illustrating an example of the synonym data. The example of FIG. 7 shows synonyms related to the name of the attacker. For example, the attacker “ABC10” is associated with synonyms such as “Gold” and “Rock”. For the instruction information including a predetermined term of “ABC10”, the determination unit 121 identifies synonyms such as “Gold” and “Rock” associated with “ABC10” from the synonym data. Then, the determination unit 121 may reflect the fact that the synonym having been identified exists as a synonym of the predetermined term in the prompt. That is, for a term used in information indicating a theme included in the instruction information, the term having a synonym, the determination unit 121 may determine a prompt that instructs treatment of the term and the synonym in a similar manner.

For example, a prompt for the purpose of organizing information regarding the attacker “ABC10” is assumed to be determined based on the instruction information. The prompt described above may include a sentence indicating an instruction such as “ABC10 has synonyms of “Gold”, “Rock”, “X123”, and .... These synonyms should be read as “ABC10””.

The determination unit 121 may identify a synonym of a term from a prompt having been determined based on the instruction information. On the prompt having been determined, the determination unit 121 may reflect a sentence indicating that the synonym having been identified exists.

As described above, the determination unit 121 may identify a synonym of a term included in the instruction information by using the synonym data in which a synonym for each term is defined. Then, the determination unit 121 may determine a prompt including a sentence indicating that a synonym having been identified exists for a term used in information indicating a theme.

The prompt may include an instruction to output a generated sentence in which terms having synonyms are unified. For example, the prompt may include a sentence “Please output a generated sentence in which terms having synonyms are each unified into one term”.

The search unit 122 searches information related to the instruction information. The search unit 122 is an example of search means.

Specifically, the search unit 122 generates a search query based on the instruction information. At this time, the search unit 122 may extract a keyword from the instruction information. The keyword may be a word or a sentence. For example, the search unit 122 may extract information regarding a threat as the keyword from the instruction information using a learning model that has learned information regarding the threat included in a sentence. Then, the search unit 122 may generate the keyword having been extracted as the search query. The search unit 122 may further generate a search query in consideration of synonyms of terms. For example, the search unit 122 identifies a synonym of a term included in the keyword having been extracted from the instruction information using the synonym data. Then, the search unit 122 may generate a keyword including the synonym having been identified as the search query. A method for generating a search query is not limited to this example.

The search unit 122 searches the internal information storage unit 191 and the external information storage unit 192 using the search query. The internal information storage unit 191 stores a report created in the past. For example, the internal information storage unit 191 stores a report distributed in the past. At this time, the internal information storage unit 191 may store a report having been created based on a report having been output by the document creation support device 100, may store a report having been created by another device, or may store a report having been created manually. Consequently, the search unit 122 acquires a report associated with the search query as a search result, for example.

The external information storage unit 192 stores the external information having been collected by the collection server 300. Specifically, the collection unit 310 collects external information, which is information related to security, through the network as described above. Then, the collection unit 310 stores the external information in the external information storage unit 192. That is, the external information storage unit 192 stores information related to cybersecurity provided by the external server, the information having been acquired through the network. The search unit 122 searches the external information storage unit 192 using the search query. Consequently, the search unit 122 acquires external information associated with the search query as a search result, for example.

As described above, the search unit 122 searches the internal information storage unit 191 and the external information storage unit 192 for information related to the instruction information.

The input unit 123 inputs the prompt having been determined by the determination unit 121 and the search result acquired by the search unit 122 to the model management unit 210. That is, the input unit 123 inputs the prompt and the search result to the large language models. Consequently, the model management unit 210 outputs a generated sentence that is an answer to the prompt, the answer reflecting the search result. The input unit 123 is an example of input means.

Processing of each of the search unit 122 and the input unit 123 may be performed based on a framework of retrieval-augmented generation (RAG). That is, the large language models refer to the information included in the search result, and output the generated sentence associated with the prompt.

The report generation unit 124 generates a report based on the generated sentence having been output by the model management unit 210. Specifically, the report generation unit 124 acquires the generated sentence having been output. Then, the report generation unit 124 converts the generated sentence having been acquired into a report format. For example, items such as a title, details, an information source, and an attacker are assumed to be defined as the report format. The report generation unit 124 may generate the report by extracting information associated with each of the items from the generated sentence and inputting the information into the report format.

At this time, the report generation unit 124 may generate the report using a learning model that learns a predetermined sentence and a result of converting the predetermined sentence into the report format. Specifically, the report generation unit 124 may regard an output obtained by inputting a generation plan having been acquired to the learning model as the report. Alternatively, the prompt is assumed to include an instruction to organize information for each of the items. For the instruction, the report generation unit 124 may generate the report by extracting information for each of the items and inputting the information having been extracted to corresponding one of the items in the report format.

A method for generating the report is not limited to this example. For example, the report generation unit 124 may regard the generated sentence directly as the report.

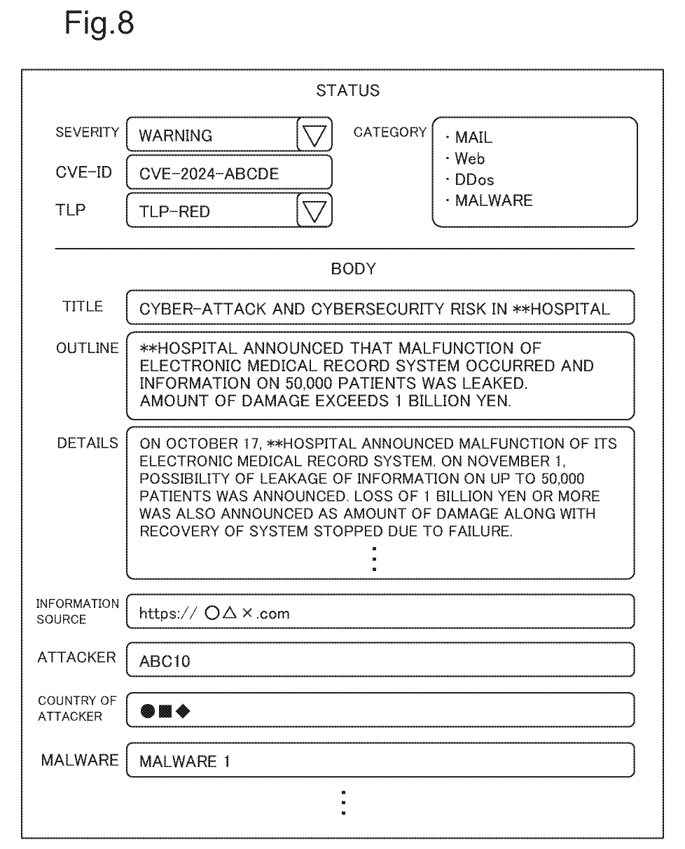

FIG. 8 is a diagram illustrating an example of the report. The example of FIG. 8 shows the report including a status and a body. The status is meta-information related to contents of the report. The example of FIG. 7 shows items of severity, a common vulnerabilities and exposures-identifier (CVE-ID), a traffic light protocol (TLP), and a category as the status. The severity indicates a scale of damage related to cases summarized in the report. The CVE-ID is information for identifying vulnerability in a product. The TLP is information for defining a boundary of information sharing. The category indicates a keyword related to the cases summarized in the report. The information on the status may be extracted from the search result, or may be generated from a relationship between the body and the status in a past report. The information on the status is not limited to these examples.

The example of FIG. 8 also shows items such as a title, an outline, details, and an information source as the body. The items of the title, the summary, and the details may include different information depending on the reader. For the reader of a management layer, examples of an interest of the management layer include a damage scale. The example of FIG. 7 shows that information on 50,000 patients is leaked, and a loss of 1 billion yen or more occurs, as the damage scale. For the reader of an incident responder, examples of an interest of the incident responder include details of attack and a coping method. Thus, the report indicates which vulnerability has been attacked, how to deal with the vulnerability, and the like. The information on the body of the report is not limited to these examples.

As described above, the report generation unit 124 generates the report based on the generated sentences having been generated by the large language models. The report generation unit 124 is an example of report generation means.

The output unit 130 outputs the report. Specifically, the output unit 130 outputs the report having been generated to the terminal device 400. The report having been output to the terminal device 400 is output by the output device 420. For example, a report as illustrated in FIG. 8 is displayed on a display that is an example of the output device 420.

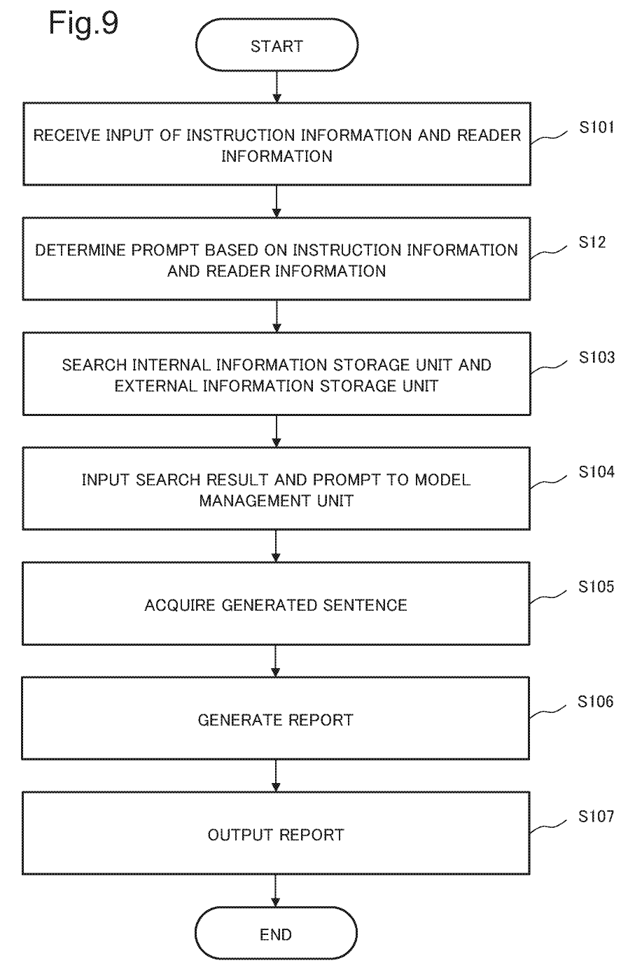

Next, an example of an operation of the document creation support device 100 will be described with reference to FIG. 9. FIG. 9 is a second flowchart illustrating an example of the operation of the document creation support device 100.

The reception unit 110 receives input of instruction information and reader information (S101). For example, the reception unit 11 may receive the input of the instruction information and the reader information by receiving the input from the user for the input display as illustrated in FIG. 5.

The determination unit 121 determines a prompt based on the instruction information and the reader information (S102). For example, the determination unit 121 identifies a prompt associated with the reader information from the prompt storage unit 193 using the instruction information and the reader information that have been input. Then, the determination unit 121 determines a prompt acquired by integrating the prompt having been identified and the instruction information as a prompt to be input to the model management unit 210.

The search unit 122 searches the internal information storage unit 191 and the external information storage unit 192 (S103). Specifically, the search unit 122 generates a search query. For example, the search unit 122 generates a keyword based on the instruction information or the prompt as the search query. Then, the search unit 122 searches the internal information storage unit 191 and the external information storage unit 192 using the search query having been generated.

The input unit 123 inputs a search result and the prompt to the model management unit 210 (S104). For example, the input unit 123 inputs the search result and the prompt having been determined to the large language models based on the framework of the RAG.

The report generation unit 124 acquires the generated sentence from the model management unit 210 (S105). The report generation unit 124 generates a report based on the generated sentence (S106). Then, the output unit 130 outputs the report having been generated (S107).

The operation of the document creation support device 100 is not limited to this example. For example, the processing in S102 and the processing in S103 may be performed by changing the order, or may be performed simultaneously.

As described above, the document creation support device 100 according to the second example embodiment receives the input of the instruction information including the instruction related to the contents of the report related to the cybersecurity and the reader information indicating the type of the reader. The document creation support device 100 generates the report including the information regarding the threat according to the instruction information based on the result of referring to the information related to the instruction information, the report including the interest of the reader, suitable for the type of the reader. Then, the document creation support device 100 outputs the report generated.

Consequently, the document creation support device 100 can generate a report assuming needs of the reader. That is, the document creation support device 100 can support creation of a report on cybersecurity, suitable for needs.

For example, the instruction information may include information indicating a theme of the report. At this time, the document creation support device 100 may determine a prompt including an instruction to generate a sentence according to the theme, the prompt being associated with the type of the reader. The document creation support device 100 may search information related to the instruction information. The document creation support device 100 may further input the prompt having been determined and a search result to the large language models. Then, the document creation support device 100 may generate the report based on the generated sentence generated by the large language models.

Consequently, the document creation support device 100 can acquire the generated sentence reflecting the search result of the information related to the instruction information, and thus can generate a report specialized for the information related to the instruction information. That is, the document creation support device 100 can support creation of a report suitable for the needs of the user who has input the instruction information.

At this time, the document creation support device 100 may search the internal information storage unit 191 and the external information storage unit 192 for the information related to the instruction information. For the search, the internal information storage unit 191 stores a report created in the past, and the external information storage unit 192 stores information regarding cybersecurity provided by an external server, the information being acquired through a network.

Consequently, the document creation support device 100 can output the report created in the past and a report based on a result having been obtained by referring to security information having been acquired from the outside. That is, the document creation support device 100 can support creation of the report suitable for the needs of the user.

The document creation support device 100 may identify a synonym of a term included in the instruction information by using synonym data in which a synonym for each term is defined, and determine a prompt including a sentence indicating that the synonym identified exists in a term used in the information indicating the theme.

Consequently, the document creation support device 100 can generate a report in consideration of not only a specific term but also a word indicating a concept similar to the specific term.

### First modification

The above-described example embodiment has been described with an example of determining a prompt using the prompt pattern information stored in the prompt storage unit 193 based on the instruction information and the reader information. Besides this example, a prompt may be input from the terminal device 400.

Specifically, the user inputs the prompt by using the input device 410 of the terminal device 400. The reception unit 110 receives the prompt having been input. The prompt includes instruction information and reader information. At this time, the terminal device 400 may display an interface indicating information prompting input of a prompt including the instruction information and the reader information. For example, a sentence prompting input of information indicating a theme of the report and a type of the reader may be displayed.

The determination unit 121 extracts the reader information from the prompt having been input. Then, the determination unit 121 integrates an instruction to output an interest according to the reader information extracted into the prompt input. The determination unit 121 then may determine the prompt integrated as a prompt to be input into the large language models.

### Second modification

The document creation support device 100 outputs a report that is distributed by a distribution server (not illustrated). That is, the document creation support device 100 transmits the report to the distribution server. At this time, the document creation support device 100 may transmit a report having been generated by the generation unit 120 directly to the distribution server, or may transmit a report obtained by correcting the report having been generated to the distribution server. That is, the document creation support device 100 may receive correction of the report having been generated from the user.

Specifically, the output unit 130 outputs the report having been generated to the terminal device 400. Examples of the user of the terminal device 400 include a person in charge of report creation, the person adding a correction to the report having been output. That is, the report having been output by the document creation support device 100 may be treated as a report draft in report creation of the user. For example, a report as illustrated in FIG. 8 is assumed to be output in the terminal device 400. The user corrects each item of the report using the terminal device 400. For example, the user may change a status. Alternatively, the user adds or deletes contents of a body of the report. The reception unit 110 receives the correction of the report. Then, the output unit 130 outputs the report having been corrected to the terminal device 400.

The user checks the report having been output. Then, for the report without correction point, the user determines the report. The report having been determined is transmitted to the distribution server as a determined report. For example, the document creation support device 100 transmits the determined report to the distribution server. The distribution server distributes the report having been transmitted.

### Third modification

The document creation support device 100 may generate a plurality of reports according to instruction information having been input. Specifically, the document creation support device 100 may generate a report according to the instruction information having been input for each type of a reader.

For example, the reception unit 110 receives an input of instruction information. Then, the determination unit 121 determines a prompt including an instruction to generate a sentence according to a theme indicated in the instruction information, for each type of the reader, having been preset. That is, the prompt is determined for each type of the reader, having been set. The input unit 123 sequentially inputs each prompt having been determined to the model management unit 210. The report generation unit 124 acquires a generated sentence associated with each prompt having been input. Then, the report generation unit 124 generates a report for each generated sentence.

The document creation support device 100 transmits a report associated with each report having been generated to a distribution server (not illustrated) as a determined report. The distribution server distributes each report. At this time, the distribution server may change the report to be distributed according to information on the user who will read the report. For example, the user as a reader is assumed to be able to view the report by logging in to a web application constructed by the distribution server. At this time, the distribution server may determine the report to be distributed to the user based on information on a type of the user as a reader, the information being registered.

### Fourth modification

The document creation support device 100 may cause the large language models to refer to information included in a search result based on a preset degree to be referred to.

Specifically, the input unit 123 sets a priority for each piece of information included in the search result. The priority is information indicating a degree to be referred to. The priority is set based on various types of information.

For example, the internal information storage unit 191 stores a report created in the past. The report is associated with evaluation information indicating evaluation of the report. The evaluation information may be attached by a user who has read the report in the past, for example. The evaluation information may indicate evaluation in multiple stages. The search result includes evaluation information for each report hit in the search.

The input unit 123 sets a priority for each report based on the evaluation information. For example, the input unit 123 sets a higher priority to a report with a higher evaluation.

The external information storage unit 192 includes information related to cybersecurity provided by the external server and collected by the collection unit 310, for example. At this time, an information source is indicated for each piece of information related to the cybersecurity. Examples of the information source include a uniform resource locator (URL). The search result includes information indicating the information source of information related to cybersecurity provided by the external server.

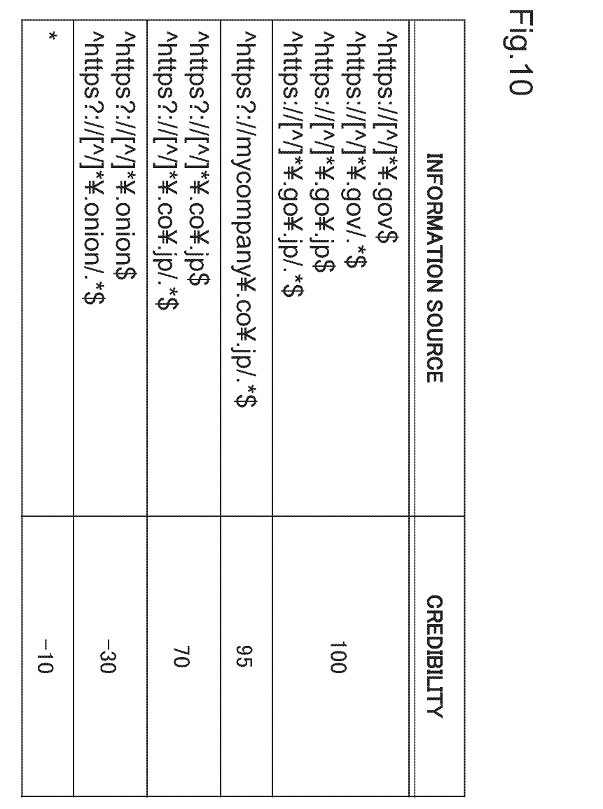

The input unit 123 sets the priority using credibility pattern information. The credibility pattern information shows credibility associated with a pattern of the information source. FIG. 10 illustrates an example of the credibility pattern information. The example of FIG. 10 shows a URL pattern as the information source. Specifically, a wildcard and a regular expression are used as the URL pattern. Then, a numerical value indicating credibility is associated with each URL pattern.

The input unit 123 identifies the credibility by using the credibility pattern information and an information source for each piece of information related to the cybersecurity. Then, the input unit 123 sets a priority for each piece of information being related to the cybersecurity and having been hit in the search, based on the credibility having been identified. For example, the input unit 123 sets a higher priority as the credibility increases.

The input unit 123 inputs the prompt having been determined and the search result to the model management unit 210 together with the priority having been set. That is, the input unit 123 instructs the model management unit 210 to refer to the search result in consideration of the priority.

As described above, the internal information storage unit 191 may store the evaluation information indicating the evaluation of the report, and the search result may include the evaluation information for each report that has been hit in the search. Then, the document creation support device 100 may set a priority indicating a degree to be referred to for each report hit in the search based on the evaluation information, and input the prompt determined, the search result, and the priority to the large language models.

The search result may include information indicating the information source of information related to the cybersecurity provided by the external server. The document creation support device 100 sets the priority indicating the degree to be referred to for each piece of information being related to the cybersecurity and being hit in the search based on the information indicating the information source by using the credibility pattern information in which the pattern of the information source is associated with the credibility. Then, the document creation support device 100 may input the prompt determined, the search result, and the priority to the large language models.

Consequently, the document creation support device 100 enables the large language models to facilitate referring to information with a higher priority. Thus, the document creation support device 100 can generate a more useful report.

In a case where information with a low priority is referred to, the document creation support device 100 may generate a report including a notice indicating that the information has been referred to. Specifically, when information in a search result with a priority lower than a threshold is referred to, the determination unit 121 determines a prompt including an instruction to output a notice indicating that information with low usefulness is included.

The input unit 123 inputs the prompt determined. That is, in a case where information in a search result with a priority lower than the threshold is referred to, the input unit 123 inputs a prompt including an instruction to output a note to the large language models. Thus, when information with a priority lower than the threshold is referred to in the search result, a generated sentence including the note is output.

Consequently, the document creation support device 100 can notify the user who is the creator of the report of a level of usefulness of the report having been generated.

### Configuration example of hardware of document creation support device

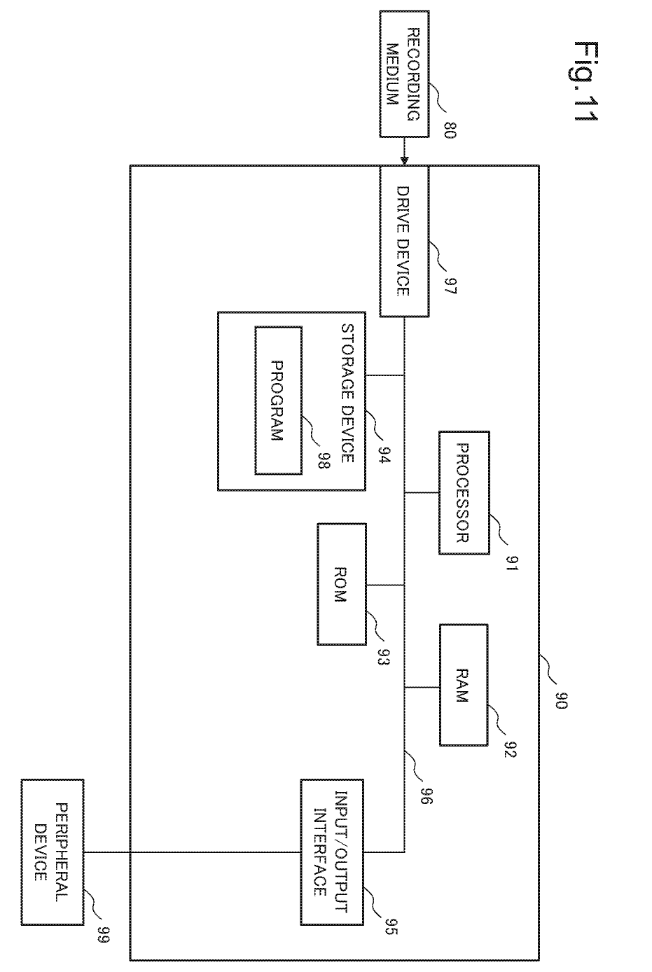

Hardware constituting the document creation support devices of the first and second example embodiments will be described. FIG. 11 is a block diagram illustrating an example of a hardware configuration of a computer device constituting the document creation support device according to each example embodiment. The computer device 90 implements the document creation support device and the document creation support method described in each example embodiment and each modification. For example, the document creation support device and the like described in each example embodiment and each modification may have the hardware configuration illustrated in FIG. 11.

As illustrated in FIG. 11, the computer device 90 includes a processor 91, a random access memory (RAM) 92, a read only memory (ROM) 93, a storage device 94, an input/output interface 95, a bus 96, and a drive device 97. The document creation support device and the like may be implemented by a plurality of electric circuits.

The storage device 94 stores a program (computer program) 98. The processor 91 executes the program 98 of the document creation support device by using the RAM 92. Specifically, for example, the program 98 includes a program that causes a computer to execute the processing illustrated in FIGS. 2 and 9. When the processor 91 executes the program 98, the function of each configuration of the document creation support device is implemented. The program 98 may be stored in the ROM 93. The program 98 may be recorded in a recording medium 80 and read by the drive device 97, or may be transmitted from an external device (not illustrated) to the computer device 90 through a network (not illustrated).

The input/output interface 95 exchanges data with a peripheral device (such as a keyboard, a mouse, or a display device) 99. The input/output interface 95 functions as means for acquiring or outputting data. The bus 96 connects each configuration.

A method for implementing the document creation support device has various modifications. For example, each configuration included in the document creation support device can be implemented as a dedicated device. The document creation support device can be implemented based on a combination of a plurality of devices.

Each example embodiment has scope that also includes a processing method for causing a recording medium to record a program for implementing each configuration in the function of each example embodiment, reading the program having been recorded in the recording medium as a code, and causing a computer to execute the program. That is, the scope of each example embodiment also includes a non-transitory computer-readable recording medium. The recording medium having recorded the above-described program and the program itself are also included in each example embodiment.

The recording medium is a floppy (registered trademark) disk, a hard disk, an optical disk, a magneto-optical disk, a compact disc (CD)-ROM, a magnetic tape, a nonvolatile memory card, or a ROM, for example, but is not limited to this example. The program having been recorded in the recording medium is not limited to a program for executing processing by itself, and programs that run on an operating system (OS) to execute processing in cooperation with other software and functions of an extension board are also included in the scope of each example embodiment.

Depending on circumstances, different information may be required for the report. For example, required information on a predetermined security incident may differ depending on a person. Thus, a report in consideration of needs in various circumstances is required to be created.

In view of the above problems, an object of the present disclosure has been made to provide a document creation support device and the like capable of supporting creation of a report regarding cybersecurity and suitable for needs.

The present disclosure enables supporting creation of a report on cybersecurity suitable for needs.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

The above-described example embodiments and modifications can be appropriately combined.

### Supplementary Note

Some or all of the above-described example embodiments may be described as the following supplementary notes, but are not limited to the following.

### Supplementary Note 1

A document creation support device including:

reception means for receiving an input of instruction information including an instruction regarding contents of a report related to cybersecurity and reader information indicating a type of a reader;

generation means for generating a report including information regarding a threat according to the instruction information based on a result of referring to information related to the instruction information, the report including an interest of the reader associated with the type of the reader; and

output means for outputting the report generated.

### Supplementary Note 2

The document creation support device described in Supplementary Note 1, in which the interest indicates information desired by the reader in the information about a threat.

### Supplementary Note 3

The document creation supporting device described in Supplementary Note 1, in which

the instruction information includes information indicating a theme of a report, and

the generation means includes:

determination means for determining a prompt including an instruction to generate a sentence according to the theme, the prompt being associated with a type of a reader;

search means for searching information related to the instruction information;

input means for inputting the prompt having been determined and a search result into a large language model; and

report generation means for generating the report based on the generated sentence generated by the large language model.

### Supplementary Note 4

The document creation support device described in Supplementary Note 3, in which

the search means searches internal information storage means and external information storage means for information related to the instruction information,

the internal information storage means stores a report created in the past, and

the external information storage means stores information related to cybersecurity provided by an external server and being acquired through a network.

### Supplementary Note 5

The document creation support device described in Supplementary Note 3 or 4, in which

the determination means identifies a synonym of a term included in the instruction information by using synonym data in which a synonym for each term is defined, and

the determination means determines a prompt including a sentence indicating that the synonym identified exists in a term used in the information indicating the theme.

### Supplementary Note 6

The document creation support device described in Supplementary Note 4, in which

the internal information storage means stores evaluation information indicating evaluation of a report,

the search result includes evaluation information for each report hit in the search,

the input means sets a priority indicating a degree to be referred to for each report hit in the search based on the evaluation information, and

the input means inputs the prompt determined, the search result, and the priority into the large language models.

### Supplementary Note7

The document creation support device described in Supplementary Note 4, in which

the search result includes information indicating an information source of information related to cybersecurity provided by an external server,

the input means sets a priority indicating a degree to be referred to for each piece of information related to the cybersecurity being hit in the search based on the information indicating the information source by using credibility pattern information in which a pattern of the information source and the credibility are associated with each other, and

the input means inputs the prompt determined, the search result, and the priority into the large language models.

### Supplementary Note 8

The document creation support device described in Supplementary Note 6 or 7, in which in a case where information in the search result with a priority lower than a threshold is referred to, the input means inputs a prompt including an instruction to output a note to the large language models.

[Supplementary Note 9]

A document creation support method including:

receiving an input of instruction information including an instruction regarding contents of a report related to cybersecurity and reader information indicating a type of a reader;

generating a report including information regarding a threat according to the instruction information based on a result of referring to information related to the instruction information, the report including an interest of the reader associated with the type of the reader; and

outputting the report generated.

### Supplementary Note 10

A program that causes a computer to execute processing including:

receiving an input of instruction information including an instruction regarding contents of a report related to cybersecurity and reader information indicating a type of a reader;

generating a report including information regarding a threat according to the instruction information based on a result of referring to information related to the instruction information, the report including an interest of the reader associated with the type of the reader; and

outputting the report generated.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Some or all of the configurations described as a Supplementary Note can be similarly dependent on various types of hardware and software, various recording means for recording software, or various systems, without departing from the above-described example embodiments.

1. A document creation support device comprising:
at least one memory configured to store instructions; and
at least one processor configured to execute the instructions to:
receive an input of instruction information including an instruction regarding contents of a report related to cybersecurity and reader information indicating a type of a reader;
generate a report including information regarding a threat according to the instruction information based on a result of referring to information related to the instruction information, the report including an interest of the reader associated with the type of the reader; and
output the report generated.

2. The document creation support device according to claim 1, wherein
the interest indicates information desired by the reader in the information about a threat.

3. The document creation support device according to claim 1, wherein
the instruction information includes information indicating a theme of a report, and
the at least one processor further performs operation to:
determine a prompt including an instruction to generate a sentence according to the theme, the prompt being associated with a type of a reader;
search information related to the instruction information;
input the prompt having been determined and a search result into a large language model; and
generate the report based on the generated sentence generated by the large language model.

4. The document creation support device according to claim 3, wherein the at least one processor further performs operation to:
search internal information storage unit and external information storage unit for information related to the instruction information,
wherein the internal information storage unit stores a report created in the past, and
the external information storage unit stores information related to cybersecurity provided by an external server and being acquired through a network.

5. The document creation support device according to claim 3, wherein the at least one processor further performs operation to:
identify a synonym of a term included in the instruction information by using synonym data in which a synonym for each term is defined, and
determine a prompt including a sentence indicating that the synonym identified exists in a term used in the information indicating the theme.

6. The document creation support device according to claim 4, wherein
the internal information storage unit stores evaluation information indicating evaluation of a report,
the search result includes evaluation information for each report hit in the search, and
the at least one processor further performs operation to:
set a priority indicating a degree to be referred to for each report hit in the search based on the evaluation information, and
input the prompt determined, the search result, and the priority into the large language models.

7. The document creation support device according to claim 4, wherein
the search result includes information indicating an information source of information related to cybersecurity provided by an external server, and
the at least one processor further performs operation to:
set a priority indicating a degree to be referred to for each piece of information related to the cybersecurity being hit in the search based on the information indicating the information source by using credibility pattern information in which a pattern of the information source and the credibility are associated with each other, and
input the prompt determined, the search result, and the priority into the large language models.

8. The document creation support device according to claim 6, wherein the at least one processor further performs operation to:
in a case where information in the search result with a priority lower than a threshold is referred to, input a prompt including an instruction to output a note to the large language models.

9. A document creation support method comprising:
receiving an input of instruction information including an instruction regarding contents of a report related to cybersecurity and reader information indicating a type of a reader;
generating a report including information regarding a threat according to the instruction information based on a result of referring to information related to the instruction information, the report including an interest of the reader associated with the type of the reader; and
outputting the report generated.

10. A non-transitory computer-readable recording medium storing a program that causes a computer to execute processing comprising:
receiving an input of instruction information including an instruction regarding contents of a report related to cybersecurity and reader information indicating a type of a reader;
generating a report including information regarding a threat according to the instruction information based on a result of referring to information related to the instruction information, the report including an interest of the reader associated with the type of the reader; and
outputting the report generated.
